(19) United States
(12) Patent Application Publication
(10) Pub. No.: US 2025/0161888 A1
(43) Pub. Date: May 22, 2025

(54) ELECTRIC WINE AERATOR

(71) Applicant: Li Ping TSAI, New Taipei City (TW)

(72) Inventor: Li Ping TSAI, New Taipei City (TW)

(21) Appl. No.: 18/397,695

(22) Filed: Dec. 27, 2023

(30) Foreign Application Priority Data
Nov. 17, 2023 (TW) 112212534

(51) Int. Cl. B01F 23/2361; B01F 23/237; B01F 35/221; B01F 35/71; B01F 101/17

(52) U.S. Cl. CPC B01F 23/2361; B01F 23/237611; B01F 35/221; B01F 35/718051; B01F 2101/17

(57) ABSTRACT

An electric wine aerator is provided, including: a body, an air inlet part, a liquid-drawing part, a liquid outlet part, and a control unit; wherein the liquid-drawing part is located at the lower end of the body and has an improved air flow path structure; when placing the electric wine aerator to a container opening, no airflow obstruction will be generated so that good air convection between inside and outside the container is achieved and the wine is drawn smoothly; the air inlet part is movably matched to a valve body with a valve stem, and a fixed base is fixed to the valve body; the valve stem is combined with a spring, to act on the fixed base and the valve body respectively; the valve stem passes through a cap assembled to the body, and a knob is provided to control the rotation of the valve stem.

### CROSS-REFERENCE TO RELATED APPLICATION

This application claims the priority of Taiwanese patent application No. 112212534, filed on Nov. 17, 2023, which is incorporated herewith by reference.

### BACKGROUND OF THE INVENTION

### 1. Field of the Invention

The present invention relates generally to an electric wine aerator, and more particularly, to an electric wine aerator for drawing out the wine liquid in a bottle and equipped with an air inlet adjustment structure, to achieve a smoother airflow and wine drawing.

### 2. The Prior Arts

Professional red wine tasters and experts must go through the “decantation” step before drinking red wine. The so-called decanting is to make the red wine come into contact with the air to produce chemical changes. As the contact area and time between the red wine and oxygen increases, the aroma in the wine blooms faster, as well as softening the tannins and creating a smooth feel.

In addition, the flavor of some drinks and other liquids can be improved by increasing the amount of dissolved oxygen when mixed with air. The early method of decanting red wine was to pour the wine into a cup and leave it for a period of time to expose it to the air. However, because it might take a long time, liquid pumps (or decanters) that could extract the liquid and mix it with air become popular, and a variety of structural versions has developed. The latest structural version of the liquid pump is disposed at the mouth of the container. The method of use is to use a pump to extract the liquid in the container out of the container into the pump body, and an air inlet structure provided on the pump body introduces external air into the body and mixes with the liquid, so that the liquid is quickly mixed with oxygen in the air, thereby achieving the effect of quickly sobering up or mixing air to enhance the flavor of the drink.

Specifically, the conventional liquid pump includes a body, an air inlet part, a liquid-drawing part, and a liquid outlet part, all provided on the body, wherein the liquid-drawing part is used to extract the liquid in the container to enter the body; the air inlet part introduces external air into the body to mix the extracted liquid, and then the liquid mixed with airflows out through the liquid outlet part. Wherein, in order to control the amount of mixed air according to the needs of different liquids, the conventional liquid pump is designed to configure the air inlet part as a structure with adjustable airflow; the liquid-drawing part has an airflow channel structure for air convection; and the liquid outlet part has a structure that seals the liquid outlet tube and the liquid outlet of the body. However, the structure of the air inlet, liquid-drawing part and liquid outlet part of the conventional liquid pump is relatively complex, and the structure for providing air convection cannot be guaranteed to be completely smooth, thus affecting the smoothness of the liquid extraction.

### Relevant Patent Technical Documents

CN 205779630
CN 206590882
CN 208135882

### SUMMARY OF THE INVENTION

A primary objective of the present invention is to provide an electric wine aerator with a simpler and more stable structure to achieve smoother airflow and smoother liquid extraction.

The electric wine aerator provided by the present invention includes: a body, a liquid flow path formed inside the body, and forming an extension tube at a lower end, the extension tube having a liquid inlet connected to the liquid flow path and forming at least one airflow channel extending longitudinally on a peripheral surface of the body; a liquid-drawing part, provided at a first position of the body, and the liquid-drawing part comprising: a connecting base, provided at the lower end of the body, and forming a plurality of protruding ribs on a bottom surface of the connecting base; an installation sleeve, comprising a cylinder with a central hole, a flange formed at one end of the cylinder, a plurality of fins formed on a periphery of the cylinder, and a side wall formed with at least one airflow hole penetrating the central hole and the outside, the installation sleeve being connected to the extension tube, so that the airflow hole corresponding to the airflow channel; and a liquid-drawing tube, with one end connected to the extension tube; an air inlet part, located on second position of the body, and comprising: a valve body having an air inlet valve hole; a valve stem movably matched with the valve body to control an opening size of the air inlet valve hole; a fixed base, fixed to the valve body by at least one fixing element; a spring, assembled to the valve stem, and two ends of the spring acting on the fixed base and the valve stem respectively; a cap, assembled to the body, so that one end of the valve stem passing through the cap; and a knob, located at the end of the valve stem that passing through the cap, to control the rotation of the valve stem, thereby controlling the opening size of the air inlet valve hole; a liquid outlet part, located at a third position of the body and connected to the liquid flow path of the body; and a control unit, located at a fourth position of the body, for controlling the liquid-drawing part to draw wine liquid through the liquid flow path to flow out from the liquid outlet part.

Preferably, the protruding ribs are arranged radially on the bottom surface of the connecting base. Thereby, when the container opening is adjacent to the bottom surface of the connecting base, the force can be evenly received to maintain the gap between the container opening and the bottom surface of the connecting base.

Preferably, there are a plurality of airflow holes and the airflow holes are arranged around the circumference of the extension tube to allow for smoother air convection between inside and outside the container.

Preferably, at least one notch is formed at the same position of each of the fins, and the notches form a groove along the longitudinal direction so as to further assist the smooth air convection between inside and outside the container.

Preferably, the fixing element is a bolt, passing through a screw hole formed in the fixed base to rotatably dispose the valve stem between the valve body and the fixed base. Accordingly, the best stability can be obtained.

Preferably, an outer end surface of the knob is provided with an indicator mark; when the knob is rotated, the angle at which the indicator mark points is used to indicate the opening size of the air inlet valve hole controlled by the valve stem. Accordingly, the user can select a better corresponding air intake amount according to the type of liquid to be drawn.

Preferably, a bump is formed on the side of a valve head of the valve stem, and a stepped portion is formed on an end edge of the air inlet valve hole; when the valve head is fitted in the air inlet valve hole, the bump contacts the stepped portion to allow the bump to move along the stepped portion when the valve stem is rotated to sense the opening size of the air inlet valve hole.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a three-dimensional schematic view showing the appearance structure of the present invention;

FIG. 2 is a three-dimensional exploded view showing the assembly relationship of the main components of the present invention;

FIG. 3 is a partial three-dimensional exploded view of the assembly relationship of the main components of the air inlet part, liquid-drawing part, and liquid outlet part of the present invention;

FIG. 4 is a partially enlarged three-dimensional exploded view of the assembly relationship of the main components of the air inlet part of the present invention;

FIG. 5 is a planar cross-sectional view along the V-V direction of FIG. 1; and

FIG. 6 is a planar cross-sectional view along the VI-VI direction of FIG. 1.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

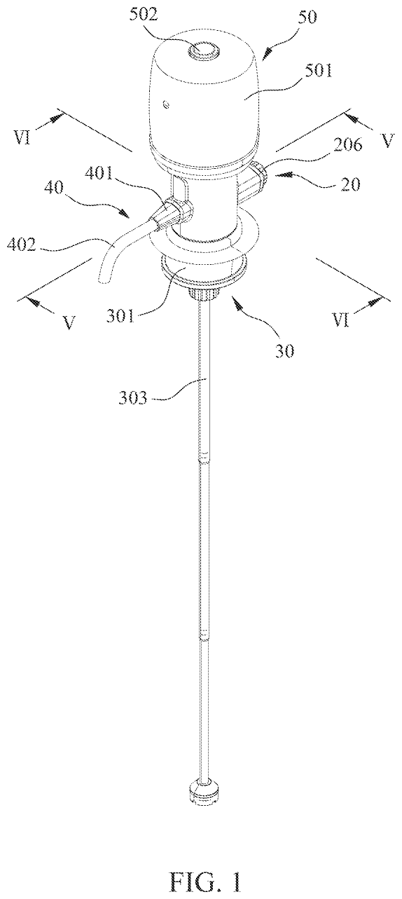

As shown in FIG. 1, the liquid pump provided by the invention includes a body 10, an air inlet part 20 disposed at a first position of the body 10 (shown as the right position in FIG. 1), a liquid-drawing part 30 disposed at a second position (shown as the lower position in FIG. 1), a liquid outlet part 40 at a third position of the body 10 (shown as the left position in FIG. 1), and a control unit 50 at the fourth position of the body 10 (shown as the upper position in FIG. 1).

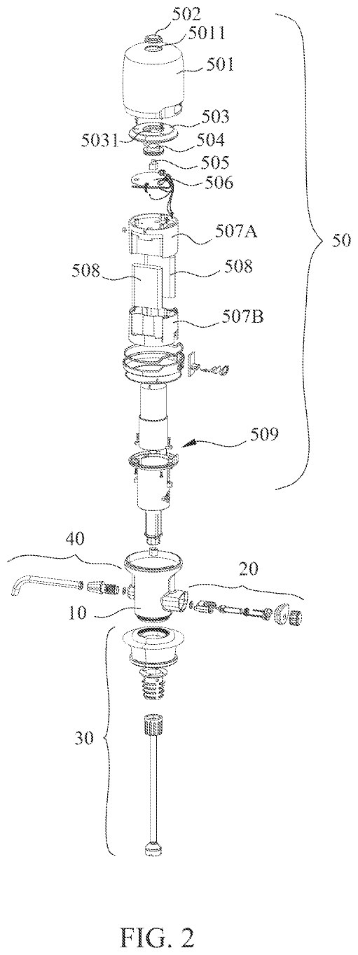

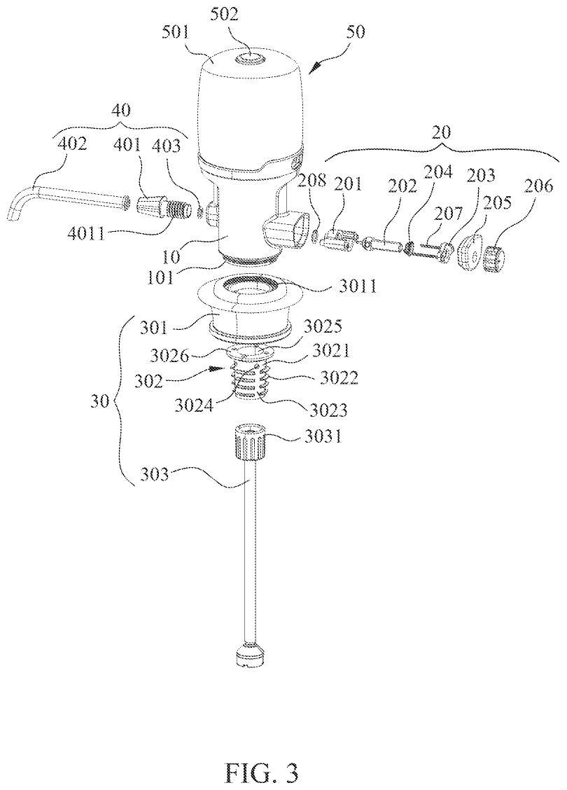

As shown in FIGS. 2 to 6, the air inlet part 20 includes: a valve body 201, a valve stem 202, a fixed base 203, a spring 204, a cap 205, and a knob 206; wherein, a liquid flow path 102 is provided inside the body 10. The liquid flow path 102 has a liquid inlet 1021, a liquid outlet 1022 and an air inlet 1023 that are connected to one another. The liquid inlet 1021 is connected to the liquid-drawing part 30, and the liquid outlet 2022 is connected to the liquid outlet part 40, and the air inlet 1023 is connected to the air inlet part 20. The control unit 50 is provided at the upper portion of the body 10, and the control unit 50 includes a button 502 provided on the upper end of a housing 501 to control a pump 509. The pump 509 operates to draw the liquid in a container 60 through the liquid-drawing part 30 into the liquid flow path 102 of the body 10 and then flows out from the liquid outlet part 40, and finally mixes with the air introduced through the air inlet part 20 during the process of passing through the liquid flow path 102. As such, the oxygen in the air causes chemical changes with the liquid to enhance the taste. The structure of the control unit 50 will be further described later.

Specifically, the air inlet part 20 includes the valve body 201, the valve stem 202, the fixed base 203, the spring 204, the cap 205, the knob 206, a fixing element 207 and a first O-ring 208; wherein, the valve body 201 is used to be screw-fitted and assembled into the body 10 so that an air inlet valve hole 2011 formed in the valve body 201 and the air inlet 1023 of the body 10 are connected correspondingly, and the first O-ring 208 is disposed between the valve body 201 and the periphery of the air inlet 1023. When the valve body 201 is locked to the body 10, the first O-ring 208 is tightened to produce a tight seal. A screw hole 2012 is respectively provided on opposite sides of the valve body 201. One end of the valve stem 202 has an enlarged valve head 2021. The front end of the valve head 2021 is axially extended to form a needle valve 2023. The valve head 2021 is movably matched with the valve body 201 to allow the needle valve 2023 to penetrate accordingly. The air inlet valve hole 2011 is controlled by controlling the axial movement of the valve stem 202 to control the extent of the blockage of the air inlet valve hole 2011 by the needle valve 2023, thereby controlling the airflow through the air inlet valve hole 2011. In a preferred embodiment of the present invention, a bump 2022 is provided on the side of the valve head 2021, and a stepped portion 2013 is formed on the end edge of the valve body 201 next to the air inlet valve hole 2011. Accordingly, when the valve head 2021 in collaboration with the valve body 201 to make the bump 2022 contact the stepped portion 2013, the bump 2022 moves along the stepped portion 2013 to gradually control the extent of the air inlet valve hole 2011 to be blocked by the needle valve 2023 when the valve stem 202 is rotated. The amount of air intake is controlled, that is, the opening size of the air inlet valve hole 2011 is controlled to control the air intake amount.

In order to rotatably position the valve stem 202 on the valve body 201, the present invention further sheathes the spring 204 behind the valve stem 202, the valve stem 202 passes through the central through hole 2031 of the fixed base 203, and then uses the fixing element to 207 to pass through the holes 2032 on both sides of the fixed base 203 to lock into the screw hole 2012 of the valve body 201, so that the opposite sides of the spring 204 are pressed against the valve head 2021 and the fixed base 203. As such, the valve stem 202 movement in the axial direction can move elastically, and accordingly the valve stem 202 is rotatably restricted between the valve body 201 and the fixed base 203. Then, the valve stem 202 passes through the perforation of the cap 205, and the knob 206 is assembled on the end of the valve stem 202. Therefore, the valve stem 202 can be rotated by rotating the knob 206, so as to control the extent of the needle valve 2023 to block the air inlet valve hole 2011 and thereby control the air intake amount. Wherein, a preferred embodiment of the fixing element 207 may be a bolt. In addition, an indicator mark (not shown in the figure) may be provided on the outer end surface of the knob 206. When the knob 206 is rotated, the opening size of the air inlet valve hole 2011 of the valve stem 202 can be known by the angle pointed by the indicator mark.

FIGS. 2, 3, 5 and 6 show the structure of the liquid-drawing part 30, which includes: a connecting base 301, an installation sleeve 302 and a liquid-drawing tube 303; an extension tube 103 is formed at the lower end of the body 10. The extension tube 103 has a liquid inlet 1021 connected to the liquid flow path 102, and at least one longitudinally extending airflow channel 1031 is formed on the peripheral surface of the extension tube 103. The airflow channels 1031 are preferably plural.

The connecting base 301 is connected to the lower end of the body 10 by a spiral locking method, and a pad 304 is provided between the end of the lower edge 101 and the bottom of a concave edge 3011. Accordingly, the lower edge 101 is locked in the concave edge 3011 to press the pad 304 tightly to produce a close fit. At the same time, the connecting base 301 is used as a component to cover the mouth of the container when the liquid pump of the present invention is connected to the container 60; the bottom surface of the connecting base 301 is formed with a plurality of protruding ribs 3012, which are preferably arranged radially.

The installation sleeve 302 is an element disposed between the body 10 and the connecting base 301 to be inserted into the mouth of the container 60. The installation sleeve 302 includes a cylinder 3021 with a central hole 3025, which is a flange 3026 formed on one end of the cylinder 3021, a plurality of soft fins 3022 are formed on the peripheral surface of the cylinder 3021, and at least one airflow hole 3024 is formed on the side wall of the cylinder 3021 to connect the central hole 3025 and the outside of the side wall. The airflow holes 3024 preferably are plural and are arranged around the circumference of the extension tube 103. At least one notch is formed at the same position of each of the fins 3022 to form at least one groove 3023 along the longitudinal direction; for example, the groove 3023 extends axially to cut the fins 3022 so that the fins 3022 form a discontinuous annular shape around the outer surface of the cylinder 3021.

The liquid-drawing tube 303 is an element used to connect one end to the installation sleeve 302 and to draw liquid; specifically, one end of the liquid-drawing tube 303 is provided with a joint 3031, and the joint 3031 is screwed to locked to the lower end of the installation sleeve 302 to communicate with the central hole 3025, and allows the inside of the valve body 10 to communicate with the outside through the airflow hole 3024 and the airflow channel 1031.

FIGS. 2, 3, 5 and 6 show the structure of the liquid outlet part 40, which includes: a tube base 401, a liquid outlet tube 402 and a second O-ring 403; wherein, a first end of the tube base 401 forms an external thread 4011. After a liquid inlet end of the liquid outlet tube 402 passes through a tube base hole of the tube base 401, the second O-ring 403 is arranged on the liquid inlet end, and then the liquid inlet end is inserted into the liquid outlet 1022 of the body 10; that is, the second O-ring 403 is disposed between the liquid inlet end of the liquid outlet tube 402 and the liquid outlet 1022, and then the tube base 401 is screwed to the internal thread of the liquid outlet end of the body 10 through the external thread 4011 so that the second O-ring 403 is pressed by the first end of the tube base 401 to form a tight fit.

FIGS. 2, 5 and 6 show the structure of the control unit 50, at least including: a shell 501, a button 502, an inner cover 503, a sealing element 504, a switch 505, a circuit board 506, a battery 508, and the pump 509; wherein, a button hole 5011 is formed on the upper end of the housing 501, and a space is formed inside to accommodate the button 502, the inner cover 503, the sealing element 504, the switch 505, the circuit board 506, the battery 508, the pump 509 and other components. The inner cover 503 is formed into a disc-shaped body, with a through hole 5031 provided at the center and a side flange 5032 formed around the inner periphery of the through hole 5031. The sealing element 504 is preferably made of silicone or rubber material, with a recessed space 5041 formed at its lower end and a side concave edge 5042 formed outside the sealing element 504. Wherein, the sealing element 504 is passed through the through hole 5031 of the inner cover 503, and the side flange 5032 and the side concave edge 5042 are tightly fitted, and then the button 502 is placed on the sealing element 504 and then arranged in a button hole 5011, and the button 502 protrudes from the button hole 5011. The switch 505, circuit board 506, battery 508, pump 509 and other components are electrically connected, and the upper and lower shells 507A and 507B cover the battery 508 and then arrange the battery 508 in the inner space of the body 10 and the outer shell 501. Accordingly, when the button 502 is pressed, the switch 505 placed in the recessed space 5041 is pushed through the soft sealing element 504, and then the pump 509 is started or stopped through the circuit on the circuit board 506.

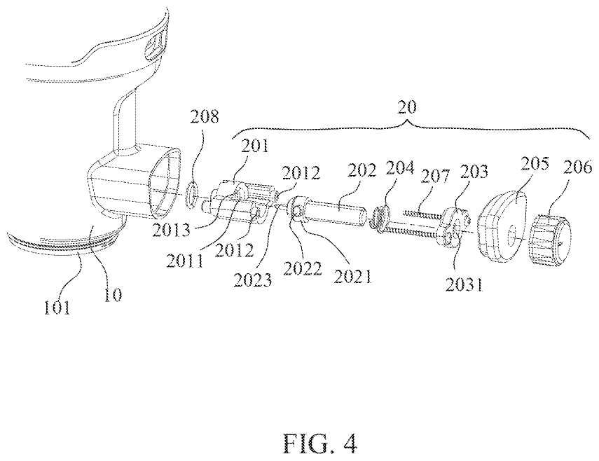

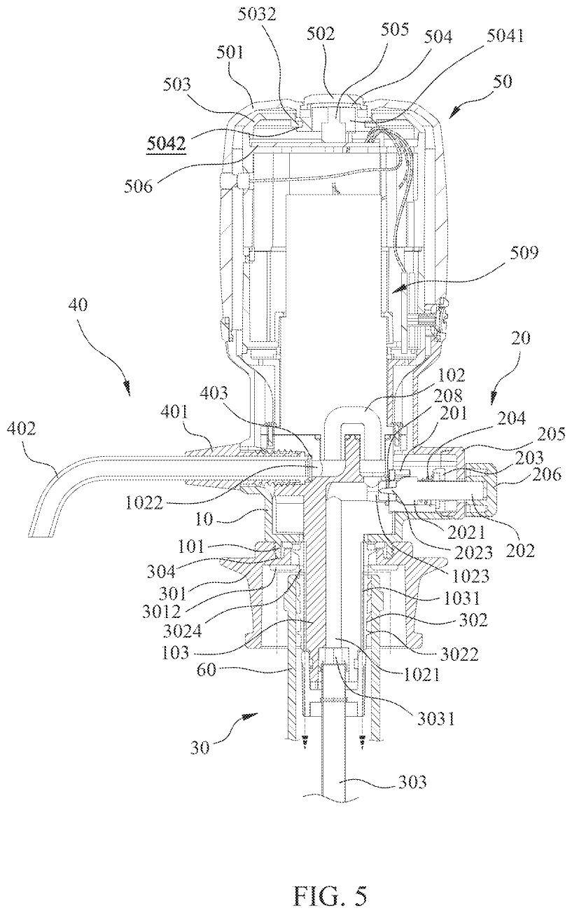

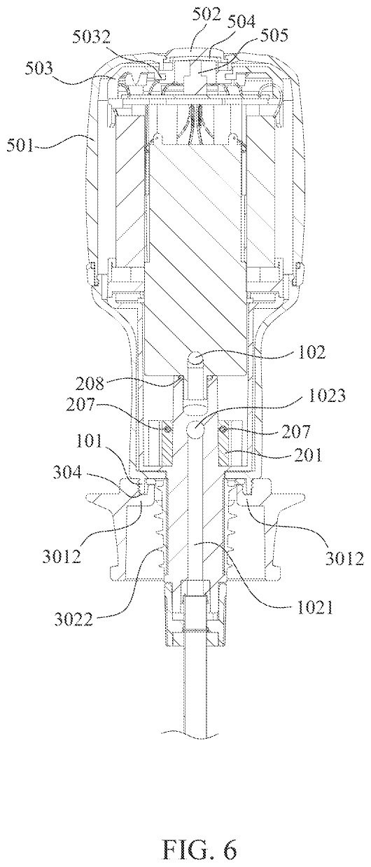

As shown in FIGS. 5 and 6, the operation of the liquid pump of the present invention includes, first, extending the liquid tube 303 of the liquid tube 30 into the container 60 (such as a wine bottle), and then pressing the button 502 of the control unit 50 to start the pump 509 to draw the liquid in the container 60 through the liquid-drawing tube 303 and the liquid flowing out through the fluid flow path 102 and the liquid outlet tube 402. During the process, the knob 206 can be rotated appropriately to adjust the valve body 201. According to the opening size of the air inlet valve hole 2011, when the liquid quickly passes through the fluid flow path 102, a negative pressure will be formed at the air inlet valve hole 2011 based on Bernoulli's law, thereby introducing external air through the air inlet valve hole 2011. The liquid is mixed in the liquid flow path 102 with the introduced air, and the liquid mixed with air flows out from the liquid outlet tube 402. At the same time, external air can smoothly enter the air container 60 through the airflow hole 3024 and the airflow channel 1031 to generate convection (the airflow direction shown by the dotted line in FIG. 4), so that the liquid can be smoothly drawn. When cleaning is required after use, the aforementioned sealing structure can prevent water from penetrating into the body 10 and the control unit 50 to affect the operation of the components or even cause damage.

In summary, the electric wine aerator of the present invention not only simplifies the structure of the electric wine aerator equipped with an air inlet adjustment structure, but also makes the airflow introduced into the air smoother, to make the liquid intake smoother and more practical.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electric wine aerator, comprising:
a body, a liquid flow path formed inside the body, and forming an extension tube at a lower end, the extension tube having a liquid inlet connected to the liquid flow path and forming at least one airflow channel extending longitudinally on a peripheral surface of the body;
a liquid-drawing part, provided at a first position of the body, and the liquid-drawing part comprising:
a connecting base, provided at the lower end of the body, and forming a plurality of protruding ribs on a bottom surface of the connecting base;
an installation sleeve, comprising a cylinder with a central hole, a flange formed at one end of the cylinder, a plurality of fins formed on a periphery of the cylinder, and a side wall formed with at least one airflow hole penetrating the central hole and the outside, the installation sleeve being connected to the extension tube, so that the airflow hole corresponding to the airflow channel; and
a liquid-drawing tube, with one end connected to the extension tube;
an air inlet part, located on second position of the body, and comprising:
a valve body having an air inlet valve hole;
a valve stem movably matched with the valve body to control an opening size of the air inlet valve hole;
a fixed base, fixed to the valve body by at least one fixing element;
a spring, assembled to the valve stem, and two ends of the spring acting on the fixed base and the valve stem respectively;
a cap, assembled to the body, so that one end of the valve stem passing through the cap; and
a knob, located at the end of the valve stem that passing through the cap, to control the rotation of the valve stem, thereby controlling the opening size of the air inlet valve hole;
a liquid outlet part, located at a third position of the body and connected to the liquid flow path of the body; and
a control unit, located at a fourth position of the body, for controlling the liquid-drawing part to draw wine liquid through the liquid flow path to flow out from the liquid outlet part.

2. The electric wine aerator according to claim 1, wherein the protruding ribs are arranged radially on the bottom surface of the connecting base.

3. The electric wine aerator according to claim 2, wherein the number of airflow holes is plural and the airflow holes are arranged around the circumference of the extension tube.

4. The electric wine aerator according to claim 3, wherein at least one notch is formed at the same position of each of the fins, and the notches form a groove along the longitudinal direction.

5. The electric wine aerator according to claim 1, wherein he fixing element is a bolt, passing through a screw hole formed in the fixed base to rotatably dispose the valve stem between the valve body and the fixed base.

6. The electric wine aerator according to claim 5, wherein an outer end surface of the knob is provided with an indicator mark; when the knob is rotated, the angle at which the indicator mark points is used to indicate the opening size of the air inlet valve hole controlled by the valve stem.

7. The electric wine aerator according to claim 6, wherein a bump is formed on the side of a valve head of the valve stem, and a stepped portion is formed on an end edge of the air inlet valve hole; when the valve head is fitted in the air inlet valve hole, the bump contacts the stepped portion to allow the bump to move along the stepped portion when the valve stem is rotated to sense the opening size of the air inlet valve hole.

8. The electric wine aerator according to claim 1, wherein the liquid outlet part comprises:
a tube base, forming an external thread on a first end of the tube base;
a liquid outlet tube, with a liquid inlet end penetrating through the tube base; and
a second O-ring, disposed between the liquid inlet end of the liquid outlet tube and the liquid outlet of the body;
wherein, the tube base is screwed to an internal thread of the liquid outlet end of the body through the external thread so that the second O-ring is pressed by the first end of the tube base to form a tight fit.
